(19) United States
(12) Patent Application Publication
(10) Pub. No.: US 2026/0287006 A1
(43) Pub. Date: Sep. 24, 2026

(54) LOCK NUT

(71) Applicant: HSIANG WU, TAINAN CITY (TW)

(72) Inventor: HSIANG WU, TAINAN CITY (TW)

(21) Appl. No.: 19/085,192

(22) Filed: Mar. 20, 2025

(51) Int. Cl. F16B 39/12; F16B 39/30

(52) U.S. Cl. CPC F16B 39/12; F16B 39/30

(57) ABSTRACT

A lock nut includes a head, a nut thread unit spirally formed on an inner wall of the head, and an opening allowing an insertion of a fastening unit with fastening threads. The nut thread unit has a plurality of thread segments. At least one thread segment includes a first upper flank section and a first lower flank section which are respectively extended outwards from the inner wall and also includes a second upper flank section and a second lower flank section which converge at a thread crest. The extensions of the first upper flank section and the first lower flank section define a pitch area. The thread crest is situated in the pitch area to provide a misaligned portion whereby the fastening threads are wedged tightly into the nut thread unit to achieve a self-locking effect and prevent the head from being rotated reversely or from getting loose.

### BACKGROUND OF THE INVENTION

### 1. Field of the Invention

This invention relates to a nut and relates particularly to a lock nut.

### 2. Description of the Related Art

Nut is considered a daily necessity and usually used in conjunction with a fastening unit. The cooperation of the nut and the fastening unit is widely applied in different fields. Referring to FIGS. 1 and 2, a conventional nut 1 comprises a head 11 with an inner wall 11′, an accommodation space 12 enclosed by the inner wall 11′, a nut thread unit 13 spirally disposed on the inner wall 11′, and an opening 14 formed through an end of the inner wall 11′. Each nut thread unit 13 includes a plurality of thread segments 13′. Each thread segment 13′ includes an upper thread flank 131 and a lower thread flank 132 opposite to the upper thread flank 131. The upper thread flank 131 and the lower thread flank 132 are respectively connected to the inner wall 11′ and extended outwards from the inner wall 11′ of the head 11. An upper flank reference line 131′ is defined by the extension of the upper thread flank 131. A lower flank reference line 132′ is defined by the extension of the lower thread flank 132. A thread area T is defined between the upper flank reference line 131′ and the lower flank reference line 132′. A thread crest 133 is formed along a junction of the upper thread flank 131 and the lower thread flank 132 and situated in the thread area T. The fastening unit 21 which is adapted to engage with the nut 1 includes a plurality of fastening threads 211 as shown in FIG. 2.

Referring to FIGS. 1, 2 and 3, during an engaging operation, a washer 22 is sleevedly disposed on the fastening unit 21. The fastening unit 21 is then inserted into the accommodation space 12 through the opening 14 to allow the washer 22 to be positioned between the nut 1 and the fastening unit 21. The fastening threads 211 of the fastening unit 21 mate with the nut thread unit 13 of the nut 1 so that the nut 1 and the fastening unit 21 are engaged together tightly. Meanwhile, the washer 22 can assist in distributing the pressure to thereby prevent the wear of the nut 1 and the fastening unit 21 and achieve an anti-loosening and vibration reduction effect.

However, only when the nut 1 tightly presses the washer 22 to create a locking force by friction can the washer 22 achieve a back-stop effect, namely to prevent the head 11 from being rotated reversely. When the nut 1 and the fastening unit 21 undergo vibration or impact caused by an external force, it will cause the reverse rotation of the nut 1 and the fastening unit 21. The engagement of the nut 1 and the fastening unit 21 will become loose. Accordingly, the locking force does not exist because the washer 22 is not tightly pressed. The nut 1 and the fastening unit 21 may separate from each other. Thus, it is necessary to check and re-tighten the nut 1 and the fastening unit 21 frequently, and that is time-consuming and backbreaking. Further, the installation of the washer 22 cannot prevent the nut 1 and the fastening unit 21 from being rotated reversely, even increases the installation costs and time, and that requires to be improved.

### SUMMARY OF THE INVENTION

The object of this invention is to provide a lock nut capable of tightly interfering in an engagement with a fastening unit, thereby effectively increasing a self-locking effect and preventing the lock nut from being rotated reversely or from getting loose.

The lock nut of this invention is subjected to engage with a fastening unit which is provided with a plurality of fastening threads. The lock nut comprises a head with an inner wall, an accommodation space formed inside the head, a nut thread unit spirally formed on the inner wall of the head, and an opening formed through an end of the inner wall. Each nut thread unit has a plurality of thread segments. Each thread segment has an upper thread flank and a lower thread flank respectively connected to the inner wall of the head. An upper flank reference line is defined by the extension of the upper thread flank. A lower flank reference line is defined by the extension of the lower thread flank. Each upper flank reference line and each lower flank reference line converge at a reference base. A pitch area is defined between two adjacent reference bases while a thread area is defined between the upper flank reference line and the lower flank reference line and in opposing relationship to the pitch area. The upper thread flank of at least one thread segment has a first upper flank section and a second upper flank section different from each other. The first upper flank section is connected to the inner wall and extended along the upper flank reference line. The second upper flank section is connected to the first upper flank section. The lower thread flank of the at least one thread segment has a first lower flank section and a second lower flank section different from each other. The first lower flank section is connected to the inner wall and extended along the lower flank reference line. The second lower flank section is connected to the first lower flank section. A thread crest is formed along a junction of the second upper flank section and the second lower flank section. The thread crest deviates from one of the two adjacent reference bases so that the thread crest is situated in the pitch area to further causes the at least one thread segment to be provided with a misaligned portion. When the lock nut and the fastening unit are engaged together, the misaligned portion assists in interfering in an engagement with the fastening unit and pressing the fastening threads properly whereby the fastening threads are firmly wedged into the nut thread unit, thereby increasing the friction and attaining a tight engagement, increasing a self-locking effect, and preventing the lock nut from being rotated reversely, getting loose or separated from the fastening unit.

Preferably, the misaligned portion of the at least one thread segment goes in the direction of the lower thread flank of another adjacent thread segment while situating the thread crest in the pitch area, thus deviating the misaligned portion in an upward manner.

Preferably, the misaligned portion of the at least one thread segment goes in the direction of the upper thread flank of another adjacent thread segment while situating the thread crest in the pitch area, thus deviating the misaligned portion in a downward manner.

Preferably, respective thread crests of at least two thread segments are situated in respective pitch areas to provide respective misaligned portions. The misaligned portions are formed on a same thread segment.

Preferably, respective thread crests of at least two thread segments are situated in respective pitch areas to provide respective misaligned portions. The misaligned portions are formed on different thread segments.

Preferably, the thread crests are at an equal distance apart from each other.

Preferably, the misaligned portions are located next to each other.

Preferably, a flange is formed on an outer periphery of the head. The flange includes a connecting surface connected to the inner wall of the head and an engaging surface connected to the connecting surface. The engaging surface is inclined to a horizontal line by an angle. The horizontal line is flush with the end of the inner wall.

Preferably, the connecting surface includes a first connecting section connected to the inner wall of the head and a second connecting section connected to the engaging surface.

Preferably, at least one thread segment is formed on the connecting surface of the flange.

### BRIEF DESCRIPTION OF THE DRAWINGS

FIG. 1 is a schematic view showing a conventional nut;

FIG. 2 is an enlarged view of the encircled portion A indicated in FIG. 1;

FIG. 3 is a schematic view showing an engaging operation of the conventional nut;

FIG. 4 is a schematic view showing a first preferred embodiment of this invention;

FIG. 5 is an enlarged view of the encircled portion B indicated in FIG. 4;

FIG. 6 is an enlarged view showing the first preferred embodiment;

FIG. 7 is a schematic view showing a further variation of the first preferred embodiment;

FIG. 8 is an enlarged view of the encircled portion C indicated in FIG. 7;

FIG. 9 is a bottom plan view showing the first preferred embodiment;

FIG. 10 is a schematic view showing an engaging operation of the first preferred embodiment;

FIG. 11 is an enlarged view of the encircled portion D indicated in FIG. 10;

FIG. 12 is a schematic view showing a second preferred embodiment of this invention;

FIG. 13 is an enlarged view of the encircled portion E indicated in FIG. 12;

FIG. 14 is a schematic view showing an engaging operation of the second preferred embodiment; and

FIG. 15 is an enlarged view of the encircled portion F indicated in FIG. 14.

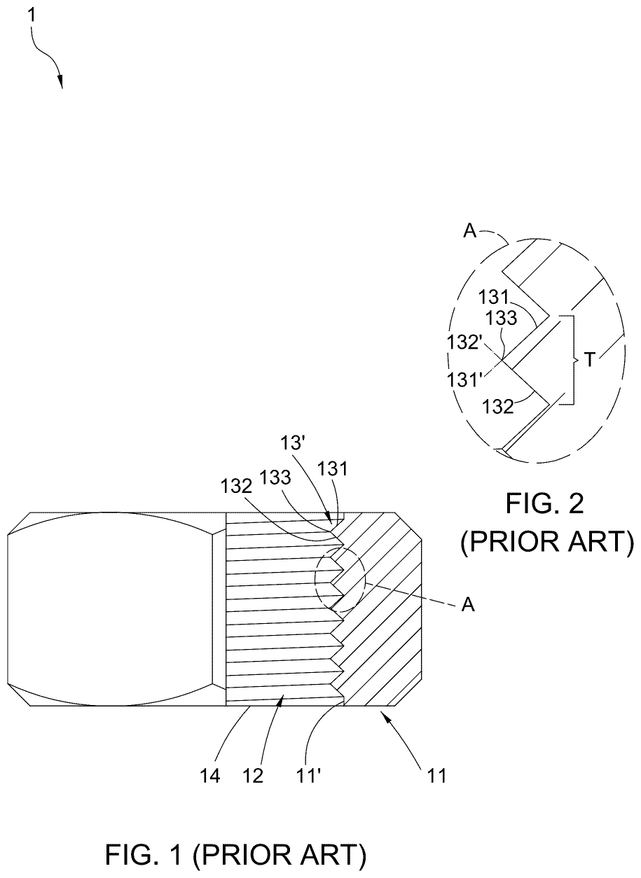

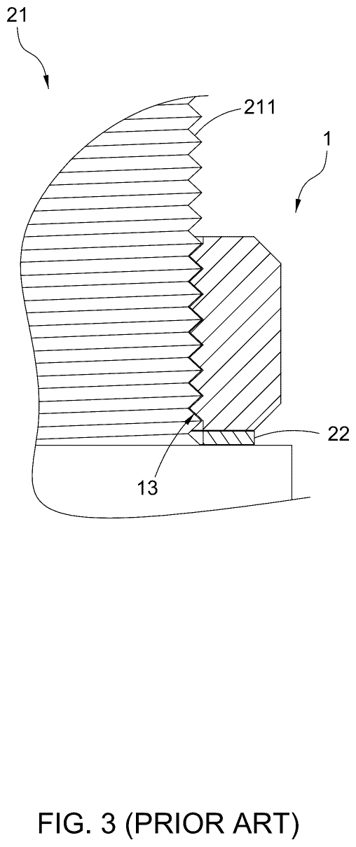

### DETAILED DESCRIPTION OF THE PREFERRED EMBODIMENTS

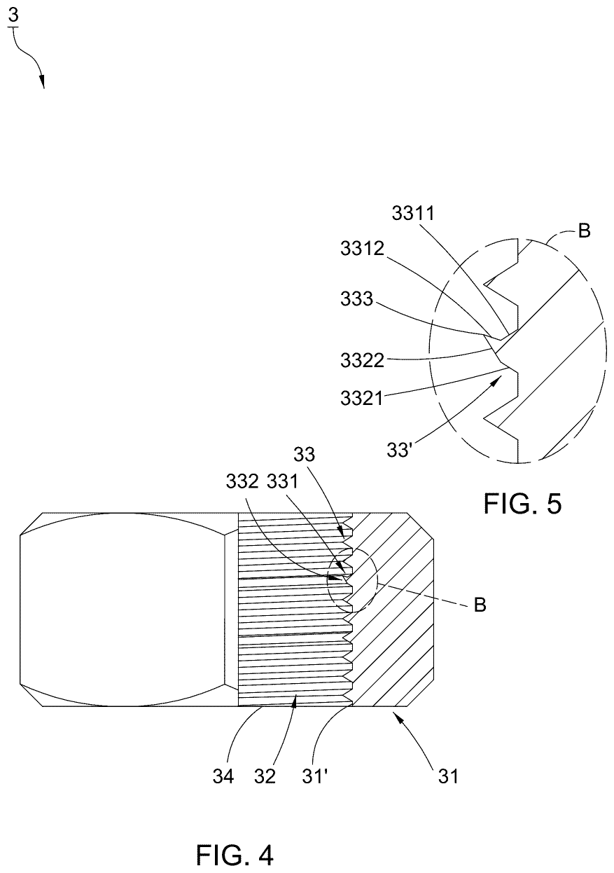

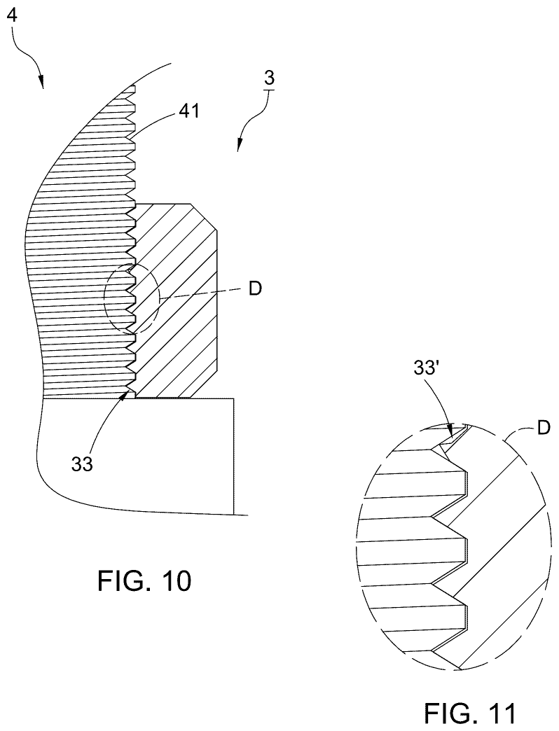

Referring to FIG. 4, a first preferred embodiment of a lock nut 3 of this invention is disclosed. The lock nut 3 includes a head 31, an inner wall 31′ formed inside the head 31, an accommodation space 32 enclosed by the inner wall 31′, a nut thread unit 33 spirally disposed on the inner wall 31′ and located in the accommodation space 32, and an opening 34 formed through an end of the inner wall 31′. The accommodation space 32 is communicated with the outside through the opening 34. Each nut thread unit 33 includes a plurality of thread segments 33′. Referring to FIG. 10, the lock nut 3 is used to engage with a fastening unit 4. The fastening unit 4 includes a plurality of fastening threads 41 spirally disposed on an outer surface thereof. The fastening threads 41 of the fastening unit 4 mate with the nut thread unit 33 of the lock nut 3.

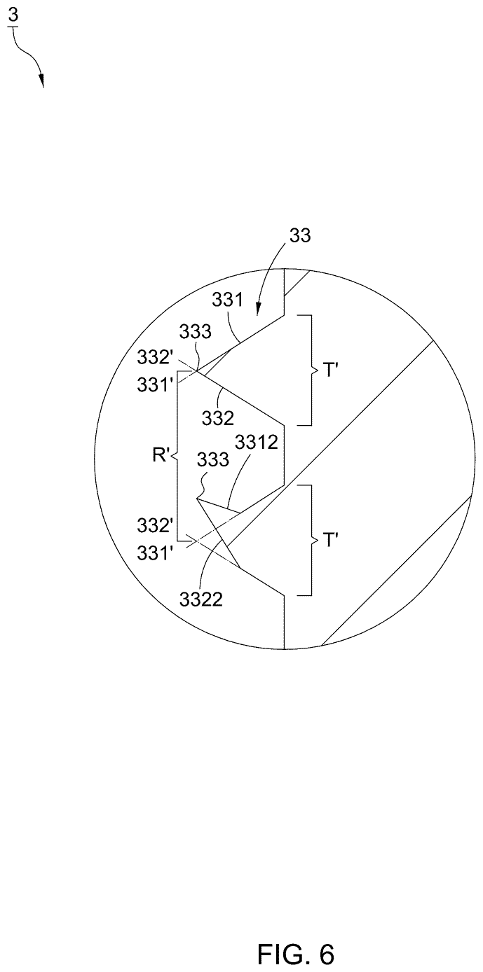

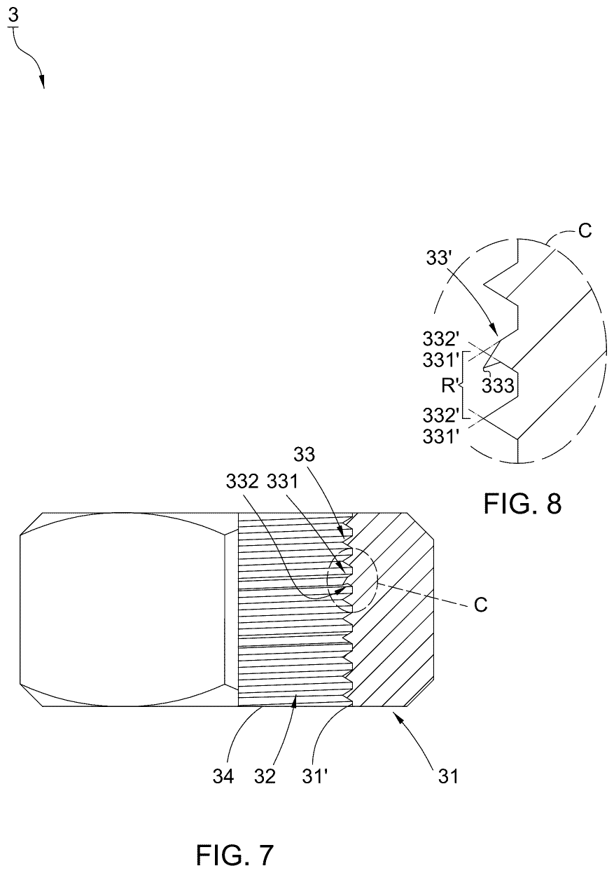

Referring to FIGS. 4, 5 and 6, each thread segment 33′ includes an upper thread flank 331 and a lower thread flank 332 in opposing relationship to the upper thread flank 331. The upper thread flank 331 and the lower thread flank 332 are respectively connected to the inner wall 31′ and slantingly extended outwards from the inner wall 31′. An upper flank reference line 331′ is defined by the extension of the upper thread flank 331. A lower flank reference line 332′ is defined by the extension of the lower thread flank 332. Referring to FIGS. 5 and 6, each upper flank reference line 331′ and each lower flank reference line 332′ meet at a reference base. A pitch area R′ is defined between two adjacent reference bases. A thread area T′ is defined between the upper flank reference line 331′ and the lower flank reference line 332′. The thread area T′ is opposite to the pitch area R′. The upper thread flank 331 of at least one thread segment 33′ includes a first upper flank section 3311 and a second upper flank section 3312 different from the first upper flank section 3311. The first upper flank section 3311 is connected to the inner wall 31′ and extended along the upper flank reference line 331′. The second upper flank section 3312 is connected to the first upper flank section 3311. The lower thread flank 332 of the at least one thread segment 33′ includes a first lower flank section 3321 and a second lower flank section 3322 different from the first lower flank section 3321. The first lower flank section 3321 is connected to the inner wall 31′ and extended along the lower flank reference line 332′. The second lower flank section 3322 is connected to the first lower flank section 3321. The second upper flank section 3312 and the second lower flank section 3322 are extended to converge at a thread crest 333. The thread crest 333 deviates from one of the two adjacent reference bases so that the thread crest 333 is situated in the pitch area R′, thereby causing the at least one thread segment 33′ to be provided with a misaligned portion.

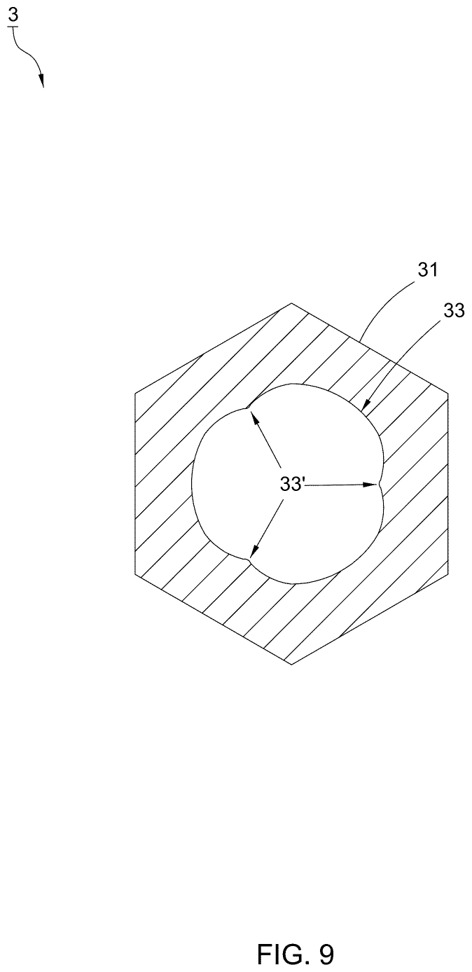

Referring to FIG. 6, the misaligned portion of the at least one thread segment 33′ goes in the direction of the lower thread flank 332 of another adjacent thread segment 33′ while situating the thread crest 333 in the pitch area R′, thus deviating the misaligned portion in an upward manner. Referring to FIG. 8, alternatively, the misaligned portion of the at least one thread segment 33′ goes in the direction of the upper thread flank 331 of another adjacent thread segment 33′ while situating the thread crest 333 in the pitch area R', thus deviating the misaligned portion in a downward manner. Referring to FIG. 9, here takes an example that respective thread crests 333 of three thread segments 33′ are situated in respective pitch areas R′ to provide respective misaligned portions. The misaligned portions are formed on a same thread segment 33'. The thread crests 333 are at an equal distance apart from each other.

Referring to FIGS. 4, 5, 10 and 11, during an engaging operation of the lock nut 3 and the fastening unit 4, the fastening unit 4 is inserted into the accommodation space 32 through the opening 34 of the lock nut 3. Because the fastening threads 41 of the fastening unit 4 mate with the nut thread unit 33 of the lock nut 3, the fastening unit 4 is engaged with the lock nut 3 by a screwing action. Because only three thread segments 33′ are provided with respective misaligned portions, that will not hinder the screwing action of the lock nut 3. After the screwing action of the lock nut 3 is complete, the misaligned portions are capable of interfering in an engagement with the fastening unit 4 and pressing the fastening threads 41 properly and tightly, thereby allowing the fastening threads 41 to be firmly wedged into the nut thread unit 33, increasing the friction, and attaining a self-locking effect. Meanwhile, the misaligned portions of the thread segments 33′ assist in preventing the reverse rotation of the lock nut 3 and the fastening unit 4 effectively and preventing the lock nut 3 and the fastening unit 4 from being loosened or separated from each other when the lock nut 3 and the fastening unit 4 undergo vibration or impact caused by an external force. Further, the lock nut 3 has a simple structure, and that facilitates a convenient installation, thereby reducing the costs and installation time.

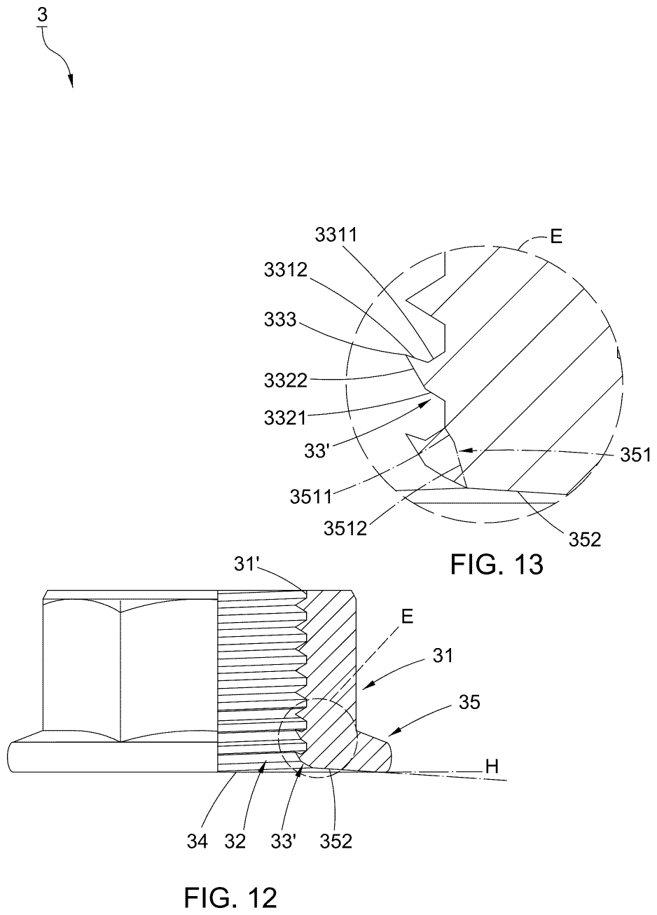

Referring to FIGS. 12 and 13 show a second preferred embodiment of the lock nut 3 of this invention. The correlated elements and the concatenation of elements, the operation and objectives of the second preferred embodiment are the same as those of the first preferred embodiment. This embodiment is characterized in that a flange 35 is formed on an outer periphery of the head 31. The flange 35 includes a connecting surface 351 connected to the inner wall 31′ of the head 31 and an engaging surface 352 connected to the connecting surface 351. The engaging surface 352 is inclined to a horizontal line H by an angle. The horizontal line H is flush with the end of the inner wall 31′. At least one thread segment 33′ is spirally disposed on the connecting surface 351 of the flange 35. The connecting surface 351 includes a first connecting section 3511 connected to the inner wall 31′ of the head 31 and a second connecting section 3512 connected to the engaging surface 352. Here takes an example that respective thread crests 333 of two thread segments 33′ are situated in respective pitch areas R′ to provide respective misaligned portions. The misaligned portions are formed on different thread segments 33'. At least one misaligned portion is provided on the at least one thread segment 33′ which is disposed on the connecting surface 351. The misaligned portions are located next to each other as shown in FIG. 13.

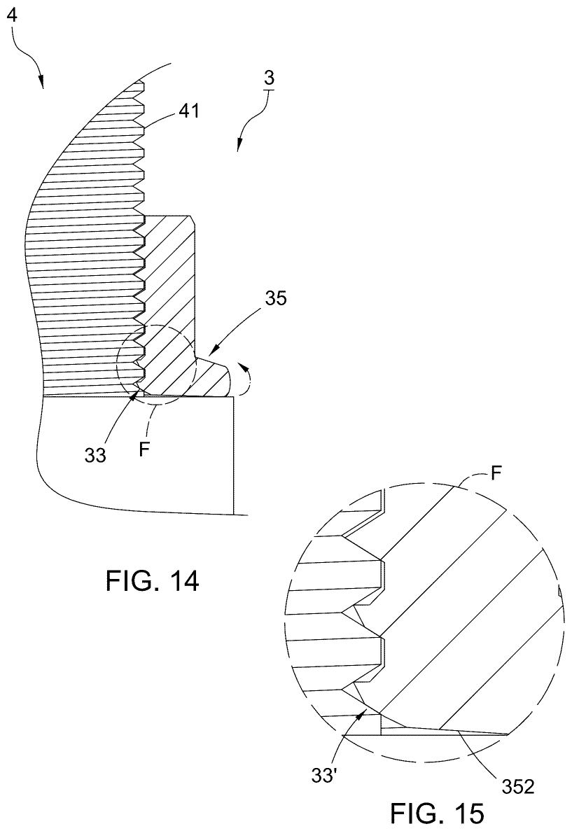

Referring to FIGS. 12 to 15, during the engaging operation of the lock nut 3 and the fastening unit 4, because the engaging surface 352 is slantingly formed and inclined to the horizontal line H by an angle to further form a gap between the engaging surface 352 and the horizontal line H, the gap allows the flange 35 to be slightly bent. After the engaging operation is complete, an elastic restoring force of the flange 35 assists in improving a sealing effect. The flange 35 also assists in distributing the pressure, protecting a surface of an object (not shown) in contact with the lock nut 3, and enlarging a contact area of the lock nut 3 and the object, thereby preventing the lock nut 3 from being reversely rotated, getting loose, or separated from the fastening unit 4. Namely, the flange 35 is a great substitute for the conventional washer to further reduce the costs and installation time. Because the misaligned portions are provided on respective thread segments 33′ situated on or adjacent to the connecting surface 351 of the flange 35 in this preferred embodiment, this embodiment not only takes an advantage of the misaligned portions to firmly interfere and wedge the fastening threads 41 of the fastening unit 4 and increase the friction, but also takes an advantage of the thread segments 33′ formed on the inner wall 31′ of the head 31 to provide a sufficient distance for preventing the reverse rotation of the head 31, thereby effectively preventing the lock nut 3 and the fastening unit 4 from being loosened or separated from each other when the lock nut 3 and the fastening unit 4 undergo vibration or impact caused by an external force.

To sum up, the lock nut of this invention takes an advantage that the thread crest of at least one thread segment deviates from one of two adjacent reference bases to allow the thread crest to be situated in the pitch area and form a misaligned portion, thereby tightly interfering in an engagement with the fastening unit, allowing the fastening threads to be firmly wedged into the nut thread unit, increasing the friction, attaining a self-locking effect, and preventing the lock nut from being rotated reversely or from getting loose.

While the embodiments of this invention are shown and described, it is understood that further variations and modifications may be made without departing from the scope of this invention.

What is claimed is:

1. A lock nut adapted to engage with a fastening unit provided with a plurality of fastening threads, said lock nut comprising:
a head with an inner wall;
an accommodation space enclosed by said inner wall of said head;
a nut thread unit spirally disposed on said inner wall of said head; and
an opening formed through an end of said inner wall for allowing an insertion of said fastening unit;
wherein said nut thread unit including a plurality of thread segments, each of said plurality of thread segments including an upper thread flank and a lower thread flank in opposing relationship to said upper thread flank, said upper thread flank and said lower thread flank being respectively connected to said inner wall and extended outwards from said inner wall, an upper flank reference line being defined by the extension of said upper thread flank, a lower flank reference line being defined by the extension of said lower thread flank, each said upper flank reference line and each said lower flank reference line meeting at a reference base, a pitch area being defined between two adjacent reference bases, a thread area being defined between said upper flank reference line and said lower flank reference line and being opposite to said pitch area;
wherein said upper thread flank of at least one thread segment includes a first upper flank section and a second upper flank section different from said first upper flank section, with said first upper flank section connected to said inner wall and extended along said upper flank reference line, and with said second upper flank section connected to said first upper flank section, said lower thread flank of said at least one thread segment including a first lower flank section and a second lower flank section different from said first lower flank section, with said first lower flank section connected to said inner wall and extended along said lower flank reference line, and with said second lower flank section connected to said first lower flank section, said second upper flank section and said second lower flank section being extended until said second upper flank section and said second lower flank section converge at a thread crest, said thread crest deviating from one of said two adjacent reference bases so that said thread crest is situated in said pitch area, and the deviation of said thread crest causing said at least one thread segment to be provided with a misaligned portion serving to interfere in an engagement with said fastening unit and press said plurality of fastening threads tightly, thereby allowing said plurality of fastening threads to be firmly wedged into said nut thread unit.

2. The lock nut according to claim 1, wherein said misaligned portion of said at least one thread segment goes in the direction of said lower thread flank of another adjacent thread segment while situating said thread crest in said pitch area, thus deviating said misaligned portion in an upward manner.

3. The lock nut according to claim 1, wherein said misaligned portion of said at least one thread segment goes in the direction of said upper thread flank of another adjacent thread segment while situating said thread crest in said pitch area, thus deviating said misaligned portion in a downward manner.

4. The lock nut according to claim 1, wherein respective thread crests of at least two thread segments are situated in respective pitch areas to provide respective misaligned portions, said misaligned portions being formed on a same thread segment.

5. The lock nut according to claim 1, wherein respective thread crests of at least two thread segments are situated in respective pitch areas to provide respective misaligned portions, said misaligned portions being formed on different thread segments.

6. The lock nut according to claim 4, wherein said thread crests are at an equal distance apart from each other.

7. The lock nut according to claim 5, wherein said thread crests are at an equal distance apart from each other.

8. The lock nut according to claim 4, wherein said misaligned portions are located next to each other.

9. The lock nut according to claim 5, wherein said misaligned portions are located next to each other.

10. The lock nut according to claim 1, wherein a flange is formed on an outer periphery of said head, said flange including a connecting surface connected to said inner wall of said head and an engaging surface connected to said connecting surface, said engaging surface being inclined to a horizontal line by an angle, said horizontal line being flush with said end of said inner wall.

11. The lock nut according to claim 10, wherein said connecting surface includes a first connecting section connected to said inner wall of said head and a second connecting section connected to said engaging surface.

12. The lock nut according to claim 10, wherein at least one thread segment is formed on said connecting surface of said flange.
